(19) United States
(12) Patent Application Publication
(10) Pub. No.: US 2023/0379921 A1
(43) Pub. Date: Nov. 23, 2023

(54) UPLINK EXTENDED REALITY SCHEDULING

(71) Applicant: QUALCOMM Incorporated, San Diego, CA (US)

(72) Inventors: Olufunmilola Omolade AWONIYI-OTERI, San Diego, CA (US); Tao LUO, San Diego, CA (US); Wanshi CHEN, San Diego, CA (US); Peter GAAL, San Diego, CA (US); Juan MONTOJO, San Diego, CA (US); Jelena DAMNJANOVIC, Del Mar, CA (US); Junyi LI, Fairless Hills, PA (US)

(21) Appl. No.: 17/664,583

(22) Filed: May 23, 2022

(51) Int. Cl. H04W 72/14; H04W 72/12; H04W 24/08

(52) U.S. Cl. CPC H04W 72/14; H04W 72/1268; H04W 72/1252; H04W 24/08

(57) ABSTRACT

Certain aspects of the present disclosure provide techniques for wireless communications by a user equipment (UE), comprising receiving, from a network entity, one or more configured grant (CG) configurations, each defining at least one CG occasion within a data period, obtaining (e.g., periodic uplink) traffic in one or more bursts, and transmitting the traffic to the network entity in multiple physical uplink shared channel (PUSCHs) within the data period.

### BACKGROUND

### Field of the Disclosure

Aspects of the present disclosure relate to wireless communications, and more particularly, to techniques for scheduling resources for uplink (UL) traffic, such as extended reality (XR) UL traffic.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communications by a user equipment (UE). The method includes receiving, from a network entity, one or more configured grant (CG) configurations, each defining at least one CG occasion within a data period; obtaining traffic in one or more bursts; and transmitting the traffic to the network entity in multiple physical uplink shared channel (PUSCHs) within the data period.

Another aspect provides a method of wireless communications by a network entity. The method includes transmitting, to a UE, one or more CG configurations, each defining at least one CG occasion within a data period; and monitoring for uplink traffic from the UE in multiple PUSCHs within the data period.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts dynamic scheduling and configured grant (CG) scheduling for uplink (UL) traffic.

FIG. 6 depicts example UL traffic delivery.

FIG. 7 depicts example downlink control information (DCI) supporting multiple continuous physical uplink shared channels (PUSCHs) per slot.

FIG. 8A and FIG. 8B depict example DCI supporting multiple PUSCHs for single and multiple transmission and reception points (TRP).

FIG. 9 depicts an example timing diagram for multiple PUSCH dynamic scheduling for extended reality (XR) traffic.

FIG. 10 depicts a call flow diagram for wireless communication between a UE and a network entity, in accordance with aspects of the present disclosure.

FIG. 11A and FIG. 11B depict multiple PUSCH scheduling, within a data period, for XR traffic, in accordance with aspects of the present disclosure.

FIG. 12 depicts a combination of configured grant (CG) and dynamic scheduling for XR traffic, in accordance with aspects of the present disclosure.

FIG. 13A and FIG. 13B depict periodic scheduling having multiple configured grant (CG) occasions for XR traffic, in accordance with aspects of the present disclosure.

FIG. 14 depicts multiple PUSCH scheduling with wake-up-signaling (WUS) for XR traffic, in accordance with aspects of the present disclosure.

FIG. 15 depicts a table describing various schemes for scheduling XR traffic, in accordance with aspects of the present disclosure.

FIG. 16 depicts a method for wireless communications.

FIG. 17 depicts a method for wireless communications.

FIG. 18 depicts aspects of an example communications device.

FIG. 19 depicts aspects of an example communications device.

### DETAILED DESCRIPTION

Aspects of the present disclosure provide apparatuses, methods, processing systems, and computer-readable mediums for scheduling resources for uplink (UL) traffic, such as uplink extended reality (XR) scheduling.

XR traffic may be characterized by a mixture of pose and video traffic to or from an XR device (e.g., a headset). Such traffic may be characterized by varying video frame size over time and bursty (quasi-periodic) packet arrival at different latencies (application jitter).

In current wireless systems (e.g., 5G new radio (NR)), a network entity may schedule radio resources periodically via a configured grant (CG). The resources within a CG allow a user equipment (UE) to transmit data to a network entity within a known timeframe, eliminating the need for costly and inefficient control scheduling associated with dynamic resource scheduling and dynamic grants (DGs).

However, 5G support for extended and augmented reality (XR/AR) has increased the need for uplink (UL) transmission of burst traffic. As noted above, such traffic may have data packets that vary widely in size, and each packet may have its own associated delay. As a result, the latency and cost benefits associated with CG scheduling may be reduced because the periodicity of a CG may not be configured to optimally transmit burst traffic with unpredictable variability.

Aspects of the present disclosure provide techniques for enhancing CG-based resource scheduling for burst traffic. In some aspects, one or more CG configurations may utilize physical uplink shared channel (PUSCH) transmissions within a CG occasion to reduce UL transmission overhead. In some aspects, a CG configuration may be implemented along with dynamic grant (DG) based scheduling to efficiently schedule data transmitted between CG occasions. In some aspects, a CG configuration may utilize a wake-up signal (WUS) to mitigate resources delay (i.e., jitter).

Enhanced CG scheduling schemes presented herein may address variabilities in burst traffic, allowing higher throughput and minimizing latency through increased flexibility of scheduling.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

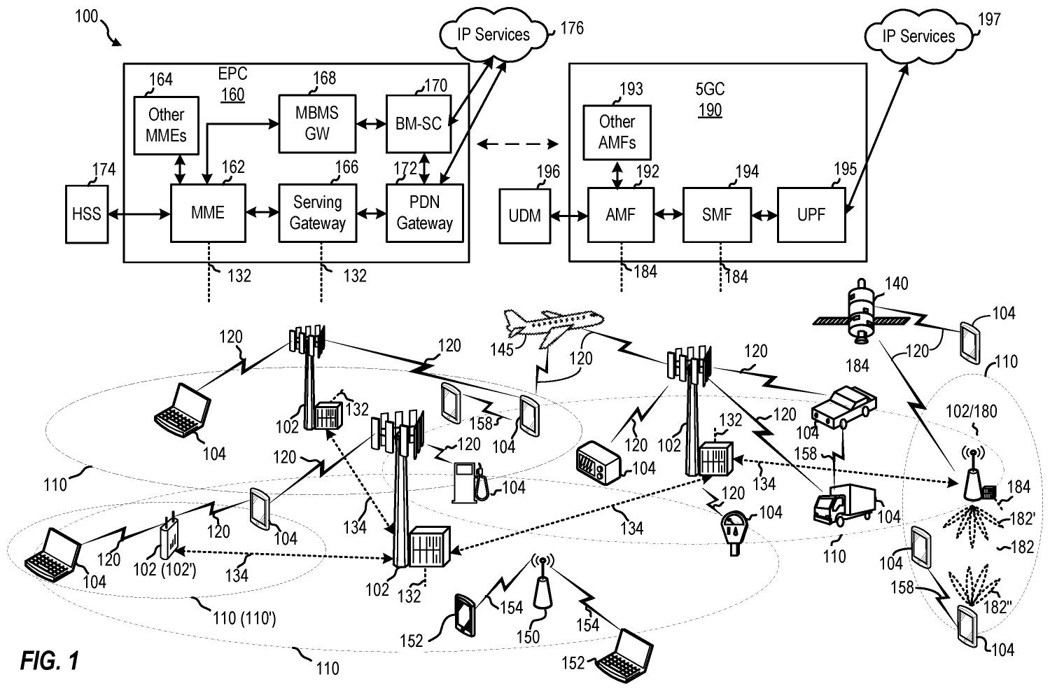

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

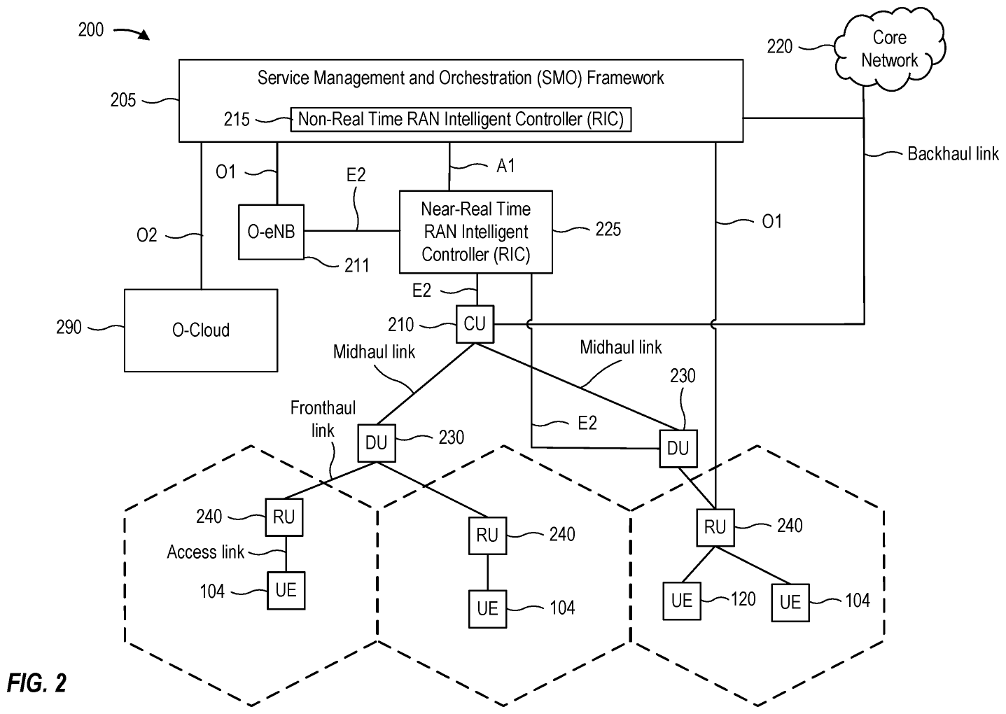

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (MC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

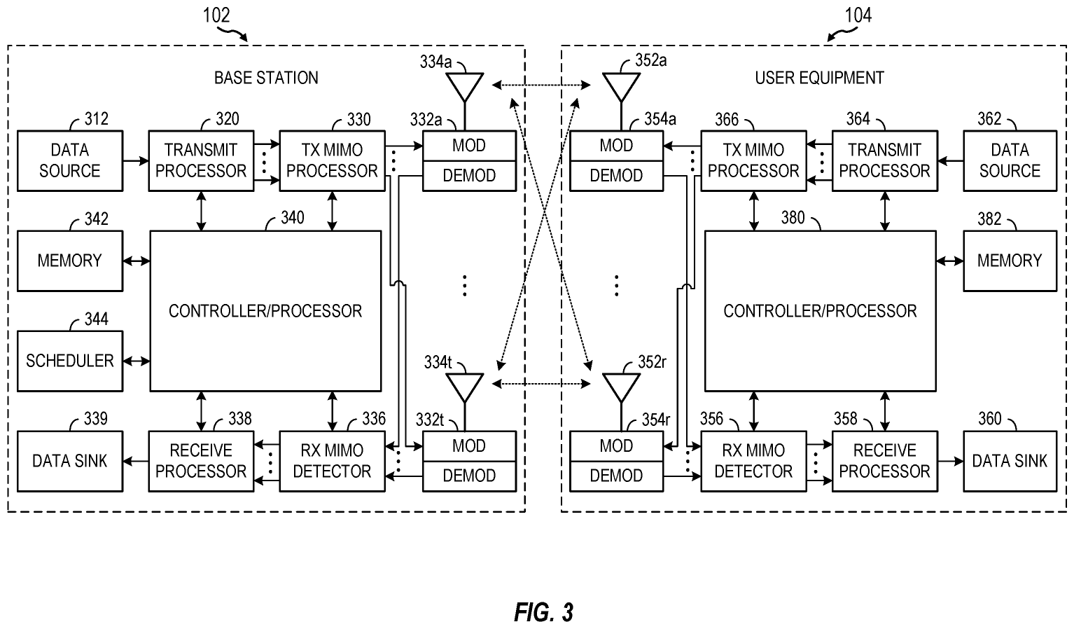

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

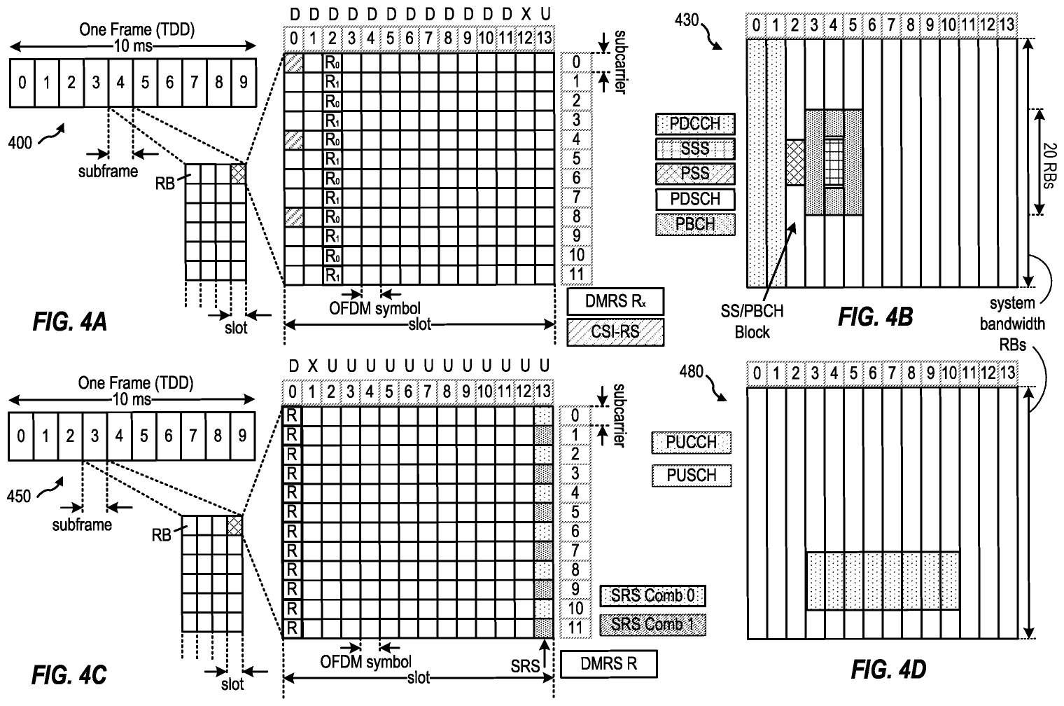

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Scheduling Resources for UL XR

Enhanced CG scheduling schemes presented herein may address variabilities in burst traffic, allowing higher throughput and minimizing latency through increased flexibility of scheduling.

As noted above, in certain wireless communication systems (e.g., a 5G NR wireless communication network), a network may configure a UE with periodic uplink resources, via a configured grant (CG). A CG may reduce the latency and resource overhead associated with resources scheduling dynamically via a dynamic grant (DG) conveyed via downlink control information (DCI) in a physical downlink control channel (PDCCH).

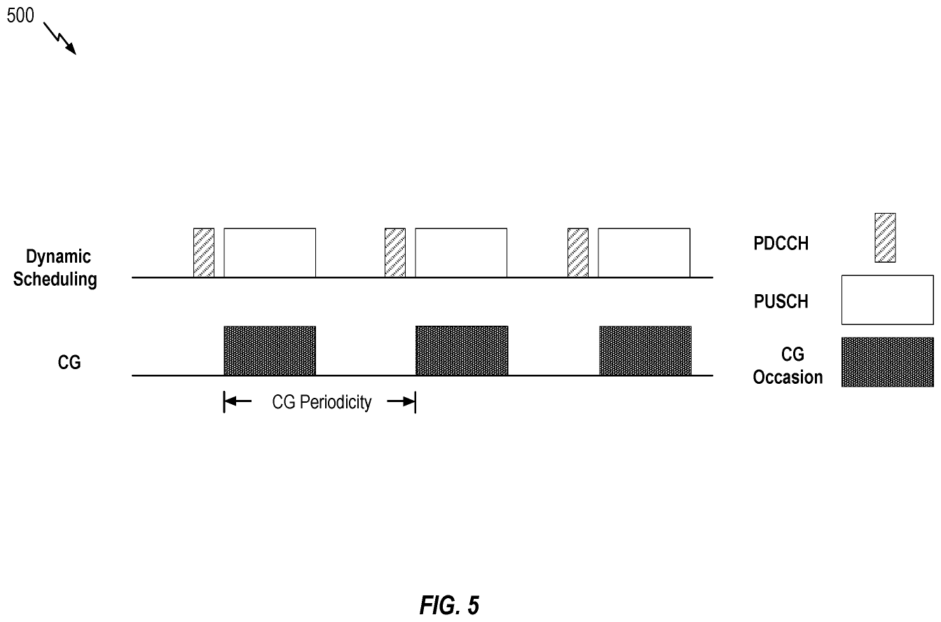

FIG. 5 illustrates both dynamic grant (DG) scheduling and CG scheduling. DGs may require a PDCCH to schedule physical uplink shared channel (PUSCH) transmissions. Thus, DG based scheduling may result in additional packet transmission delay and increased resource usage. In contrast, uplink resources scheduled via CGs occur periodically (referred to as CG occasions) without the need for control signaling, eliminating expense and delay associated with DGs.

CG parameters are typically configured via RRC signaling and the activation of the grant is through RRC or L1 signaling. Typically, the periodicity and configured parameters (e.g., number of resource blocks (RBs), modulation and coding scheme (MCS), number of repetitions) are the same for all CG occasions in the CG configuration.

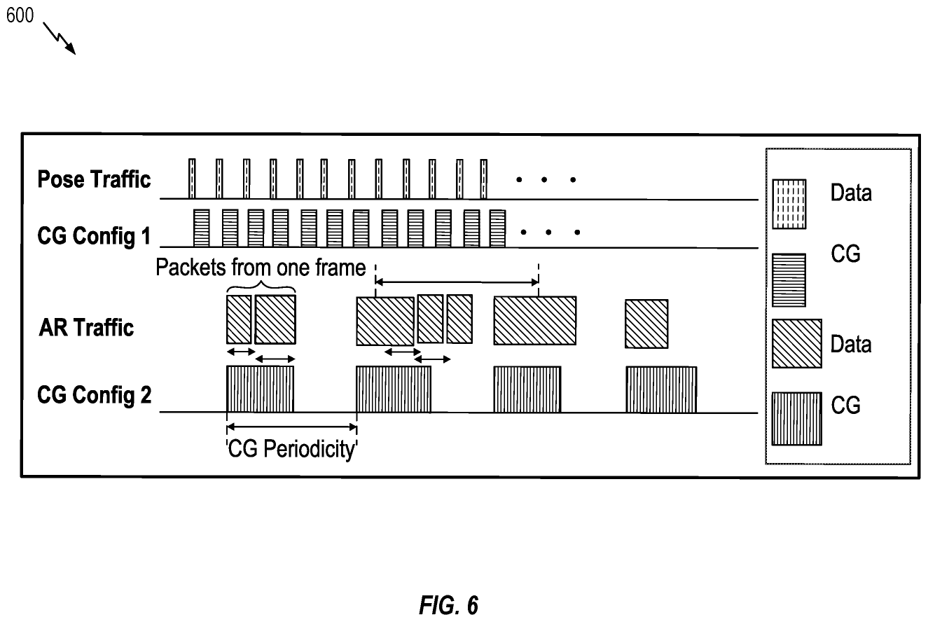

Conventional CG scheduled uplink resource allocation may not be optimal for certain type of uplink traffic, such as extended reality (XR) and augmented reality (AR) related traffic. In XR use case, certain types of uplink data (e.g., 3D estimation of a human body pose or must “Pose” data) may be periodically generated, as illustrated in the top timeline of FIG. 6. If a CG configuration matches the periodicity of the data arrival, such as CG Config 1 shown in FIG. 6, the CG resources may be well-suited for delivering the UL traffic.

However, other types of traffic, such as AR traffic (e.g., video or other media) traffic, as illustrated in the third timeline of FIG. 6, may have packet sizes and transmission delays that vary broadly. Variability in both the numbers of packets per burst and size of each packet within a burst may render the latency benefits of CG scheduling moot. For example, packets from one or more AR traffic bursts may require more UL resources than allocated in a first CG occasion period. As a result, according to some CG configurations, some of the AR traffic will be delayed until the next CG occasion, as illustrated in the fourth timeline of FIG. 6 for CG Config 2.

In some cases, AR and XR traffic may also be transmitted in multiple traffic flows (streams) and configured with variable parameters and characteristics, which present further challenge for CG scheduled resources. In some cases, a CG scheduling configuration may be unable to meet the data transmission requirements of the multi-flow AR/XR traffic. In some cases, packets from one or more traffic bursts may have periodicity that is mismatched with the periodicity of CG occasions. As a result, AR traffic bursts falling outside of the CG occasion within a CG period may be delayed until the next CG period. This delay may continue as long as the traffic and CG periods are mismatched. In some cases, resources for actual traffic transmission may be out of sync with resources for transmission scheduled via CGs, causing transmission jitter. UL jitter may be caused by encoding delay at the UE. Jitter may also cause latency in UL transmission not easily remedied with periodic scheduling.

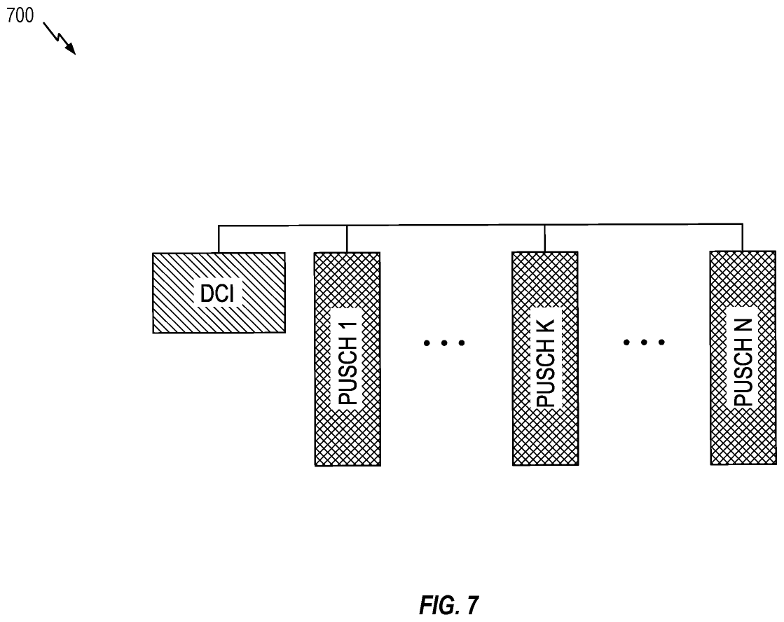

In some cases, a dynamic grant may be used to schedule multiple PUSCHs (with a single DCI), as illustrated in FIG. 7. The DCI of FIG. 7 may address certain variabilities associated with bursty traffic (e.g. AR/XR traffic). For example, an UL burst having a long channel occupancy time (COT) may be scheduled on multiple continuous PUSCHs over multiple slots/mini-slots by single a DCI. As a result, the UL burst may require fewer instances of expensive control signaling. In such cases, each transmission block (TB) may be mapped to one slot or one mini-slot. The PUSCHs of FIG. 7 may have different lengths, but are contiguous in time domain, and may share most parameters, except hybrid automatic repeat request (HARQ) process identifier, redundancy version ID (RVID), new data indicator (NDI), and time domain resource allocation (TDRA).

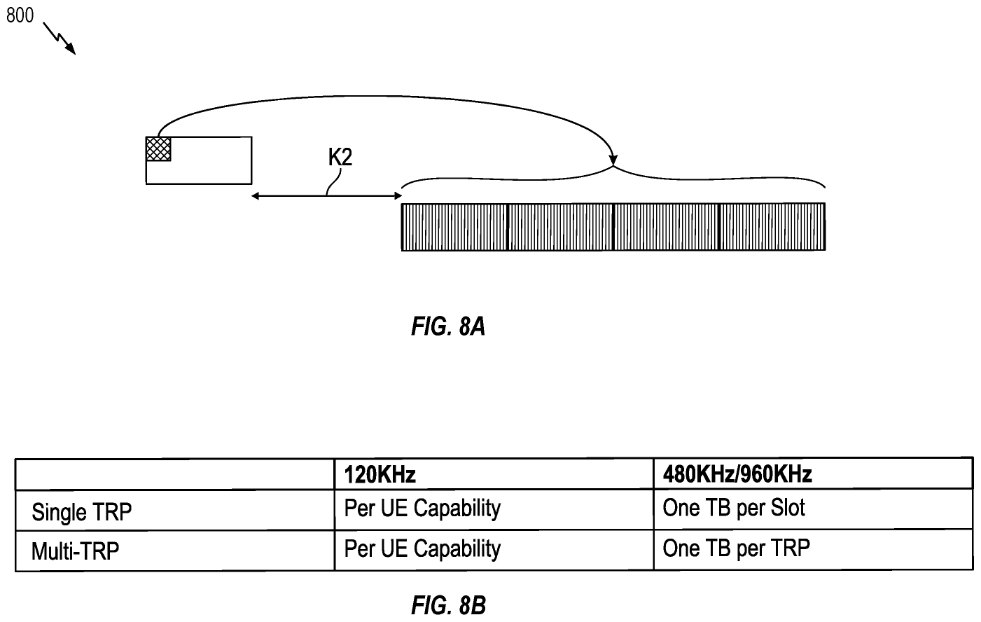

As illustrated in FIG. 8A, in some cases, a single DCI may schedule multiple PUSCHs within a single slot. In some cases, a gap between adjacent PUSCH may be allowed and there may be no maximum gap limitation (except those derived from RRC parameters). A TDRA may indicate PUSCHs that are in consecutive or non-consecutive slots by configuring start and length indicator value (SLIV), mapping type, and scheduling offset (e.g., K₀ or K₂) for each PUSCH in a row of a TDRA table. As illustrated in FIG. 8B, depending on UE capability, there may be one TB per slot in a single transmission and reception point (TRP) configuration, and one TB per TRP in a multiple TRP configuration.

In one example, a single DCI of DCI format DCI 0_1 may schedule multiple PUSCHs. In this case, frequency domain resource allocation (FDRA), MCS, scheduling request indicator (SRI), number of layers, precoding, antenna ports, and open loop power control are not changed, and apply to all scheduled PUSCHs. A new TDRA table supporting multiple SLIVs (up to 8) may be defined. Discontinuous SLIVs are also supported. This format may have one bit of NDI per TB, and one bit of RVID per TB if multiple TB are scheduled (e.g., between RVID 0 and 2) or two bits if only one PUSCH is scheduled. The HARQ ID may apply to the first scheduled PUSCH. Each additional scheduled PUSCH may have an incremented HARQ ID.

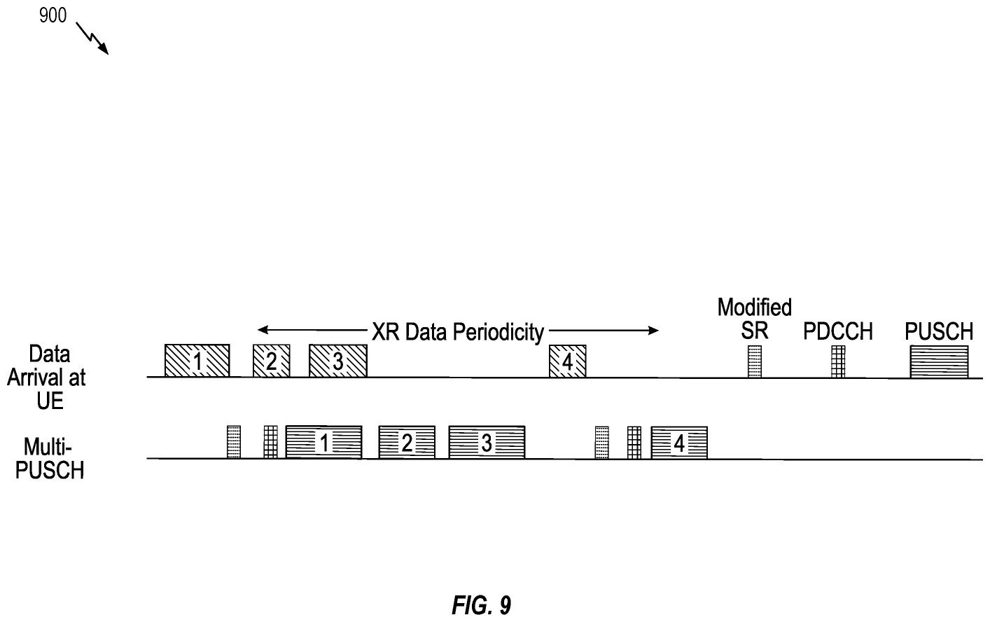

In some cases, a single DCI that schedules multiple PUSCHs may be used to increase efficiency for AR/XR scheduling. As illustrated in FIG. 9, different bursts may arrive in different periods. In the illustrated example, bursts 1-3 arrive in one data period, while burst 4 arrives in another period. As illustrated, the UE may request uplink resources for transmitting bursts 1-3, via a first SR. In response, the network may send a DCI (via PDCCH) that schedules multiple PUSCHs, allowing for transmission of bursts 1-3. As shown, only one scheduling request (SR) and one PDCCH may be needed to transmit bursts 1-3, reducing the overall control signaling requirements associated with XR traffic falling within a single XR data period. In this example, burst 4 arrives after the first XR data period, thus requiring an additional SR and DL grant (for just the single burst).

In many cases, the packet size and number of packets per burst may vary. In such cases, an SR may be request for resources including parameters (e.g., number of PUSCH, MCS). For XR, the MCS may vary to accommodate the varying packet sizes.

Aspects of the present disclosure provide techniques for enhancing CG scheduling for burst traffic (e.g., AR and XR traffic). In some aspects, one or more CG configuration may allow for multiple PUSCH transmissions within a CG occasion to reduce UL transmission overhead. In some aspects, CG and DG scheduling may be combined to efficiently schedule uplink traffic. In some aspects, a CG configuration may combined with a wake-up signal (WUS) to reduce jitter of arrival packets. As noted above, the enhanced CG scheduling techniques proposed herein may address variabilities in AR/XR traffic, allowing higher throughput and minimizing latency through increase flexibility of scheduling.

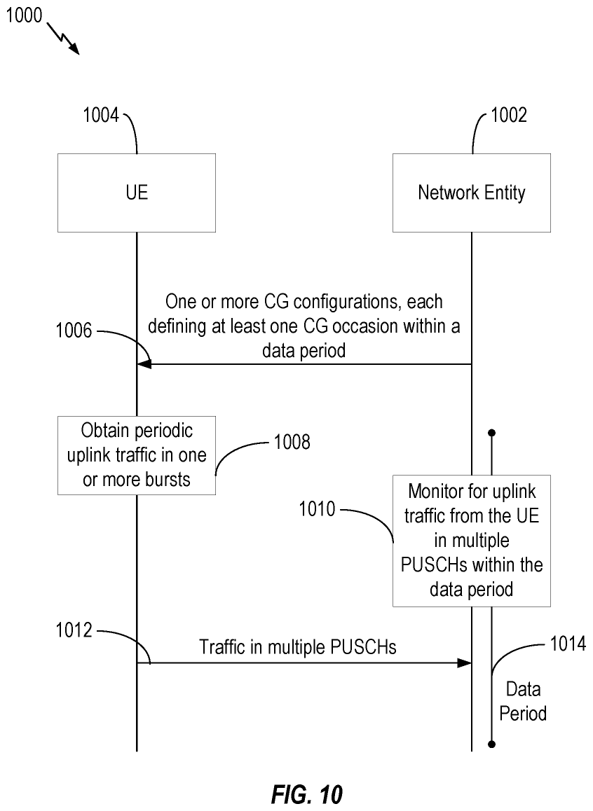

CG scheduling techniques proposed herein may be understood with reference to the call flow diagram 1000 of FIG. 10, which shows scheduling of uplink traffic from a UE 1002 to a network entity 1004. In some aspects, the network entity 1002 may be an example of the BS 102 depicted and described with respect to FIGS. 1 and 3 or a disaggregated base station depicted and described with respect to FIG. 2. Similarly, the UE 1004 may be an example of UE 104 depicted and described with respect to FIGS. 1 and 3. However, in other aspects, UE 104 may be another type of wireless communications device and BS 102 may be another type of network entity or network node, such as those described herein.

At 1006, the network entity configures the UE with one or more CG configurations, each defining at least one CG occasion within a data period 1014. At 1008, the UE obtains (e.g., periodic uplink) traffic in one or more bursts (e.g., XR traffic, such as Pose and AR traffic). As illustrated, the UE transmits the uplink traffic in multiple PUSCHs within the data period, based on the configuration (as the network entity monitors).

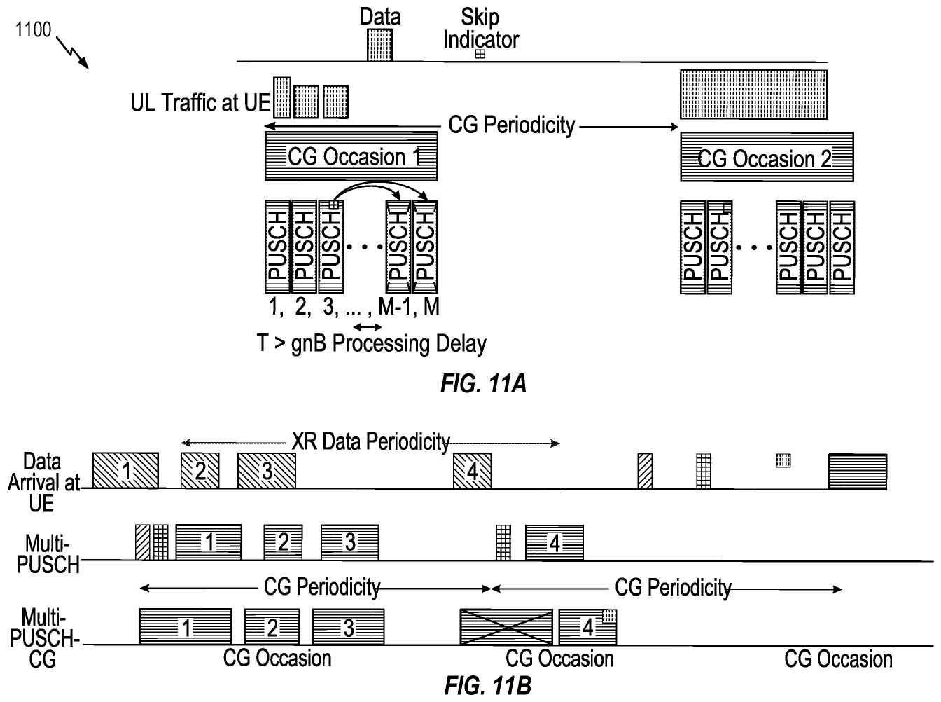

According to certain aspects, the one or more CG configurations (configured at 1006 of FIG. 10) may have multiple PUSCHs per CG occasion, as described above. In such cases, as illustrated in FIG. 11A, when one or more data bursts arrive at a UE, the UE may transmit the data bursts in multiple PUSCHs of a first CG occasion. In some cases, the UE may be configured with a maximum of PUSCHs, M, for each CG occasion. In some cases, a pre-configuration of various parameters (e.g. MCS, number of RBs, etc.) may vary across PUSCHs. In cases of little to no jitter, a network entity may place a CG occasion close to the first arrived packet. Accordingly, the UE may transmit the packet in the first PUSCH.

In some cases, the UE may send an indicator (a “skip indicator”) to inform the network entity when the UE does not intend to use all PUSCHs in a CG occasion, so that the network entity may skip monitoring one or more future PUSCHs. A UE may send this indicator prior to sending a scheduled skipped PUSCH, taking into account network entity processing time. In some cases, the indicator may indicate an end of burst for a cycle to the network entity.

In the example illustrated in FIG. 11A, the UE does not intend to use PUSCH M−1 and M. The UE sends the indicator in PUSCH 3 of CG occasion 1, allowing the network entity to skip monitoring for these PUSCHs. If a UE does not send a skip indicator (e.g., the PUSCHs of CG occasion 2), the network entity may monitor the maximum, M, number of PUSCHs. In some cases, the indicator may indicate that more PUSCHs than initially activated (e.g., PUSCHs>M) may be used within a CG configuration. This extended PUSCH indicator may be preconfigured by the network entity.

In some cases, a request for parameter changes for future PUSCHs may be piggybacked on such an indicator. The parameter changes may include changes to CG parameters (e.g., MCS, number of RBs, number of PUSCHs per CG occasion, etc.) in the same CG occasion, the next CG occasion, or a group of CG occasions. The UE may transmit a request for parameter changes on an indicator using sequence-based signaling (e.g., demodulation reference signaling (DMRS)), PDCCH (e.g., DCI), or PUSCH (e.g., medium access control (MAC) control element (CE)).

FIG. 11B illustrates a comparison of DG based scheduling and scheduling using a multiple PUSCH CG configuration. In the second timeline of FIG. 11B, a single-DCI PUSCH reduces latency for the first three traffic bursts by eliminating control signaling for each PUSCH. In the third timeline, a multiple PUSCH CG configuration reduces latency further by eliminating control signaling altogether.

According to certain aspects, the one or more CG configurations transmitted by the network entity may be configured with multiple PUSCHs and transmitted alongside a DG configuration. In many cases, a DG configuration implemented alongside a CG configuration may further reduce latency for retransmissions.

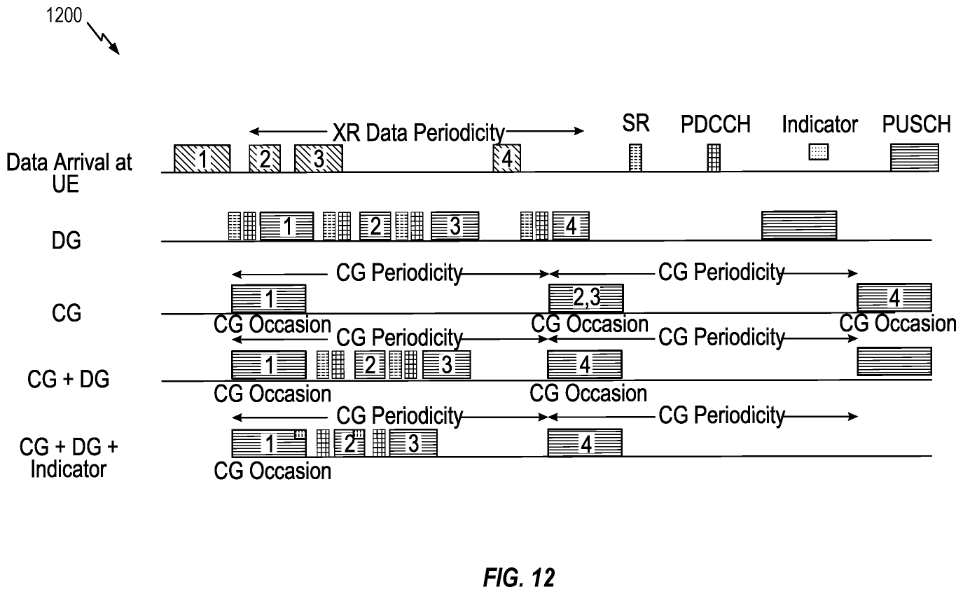

FIG. 12 illustrates scheduling of UL data transmissions with a combination of DG and CG scheduling. In the first timeline of FIG. 12, XR data traffic arrives in bursts (i.e., bursts 1-4).

The second timeline of FIG. 12 illustrates DG-based scheduling which a UE may use to transmit bursts 1-4 to a network entity. In this case, control signaling (SR, PDCCH) is required for each burst, increasing latency and resource usage, relative to the other scheduling schemes.

The third timeline of FIG. 12 illustrates periodic resource scheduling which a UE may use to transmit bursts 1-4 to a network entity. In this case, the first CG occasion may only transmit the burst 1. The UE waits until the start of the second CG period to transmit bursts 2 and 3 in the second CG occasion, and has to wait until the start of the third CG period to transmit burst 4 in the third CG occasion. Accordingly, transmission of XR traffic only on CG configured resources may be especially inefficient, in terms of latency.

The fourth timeline of FIG. 12 illustrates combination of CG and DG-based resource scheduling. In this case, burst 1 is sent in the first CG occasion. Rather than waiting for the second CG occasion, however, the UE sends an SR to request resource and receives a DG, allowing bursts 2 and 3 to be sent earlier. This allows burst 4 to be sent in the second CG occasion, rather than waiting until the third CG occasion. This combined scheduling scheme strikes a good balance, as control signaling is reduced compared to a pure dynamic scheduling configuration, and latency is reduced compared to a pure periodic scheduling configuration.

As illustrated in the fifth timeline of FIG. 12, the UE may also utilize a more data indicator when using the combined CG and DG-based resource scheduling scheme. The more data indicator may tell the network entity the UE has more uplink data and could use more PUSCH resources. Thus, the more data indicator may effectively eliminate the need for a separate SR transmission. In other words, after detecting the more data indicator, the network entity may send the PDCCH with a dynamic grant without waiting for an SR from the UE. As a result, control signaling and latency may be reduced further.

In some cases, the UE may send the (skip and/or more data) indicator via sequence based signaling (e.g., DMRS) or via PUSCH (e.g., MAC CE). In some cases, a DMRS pattern may indicate different a resource allocation. In some cases, a PUSCH-based indicator may allow for a greater indicator payload. In some cases, the indicator may be physical uplink control channel (PUCCH) based if there is uplink control information (UCI) transmitted before the resource is needed.

According to certain aspects, a network entity may configure a UE with multiple (different) CG configurations. In some cases, a network entity may activate multiple such CG configurations. As a result, a UE may transmit burst traffic in multiple CG occasions falling within a single data period, even where the CG period of each CG configuration may only have one CG occasion.

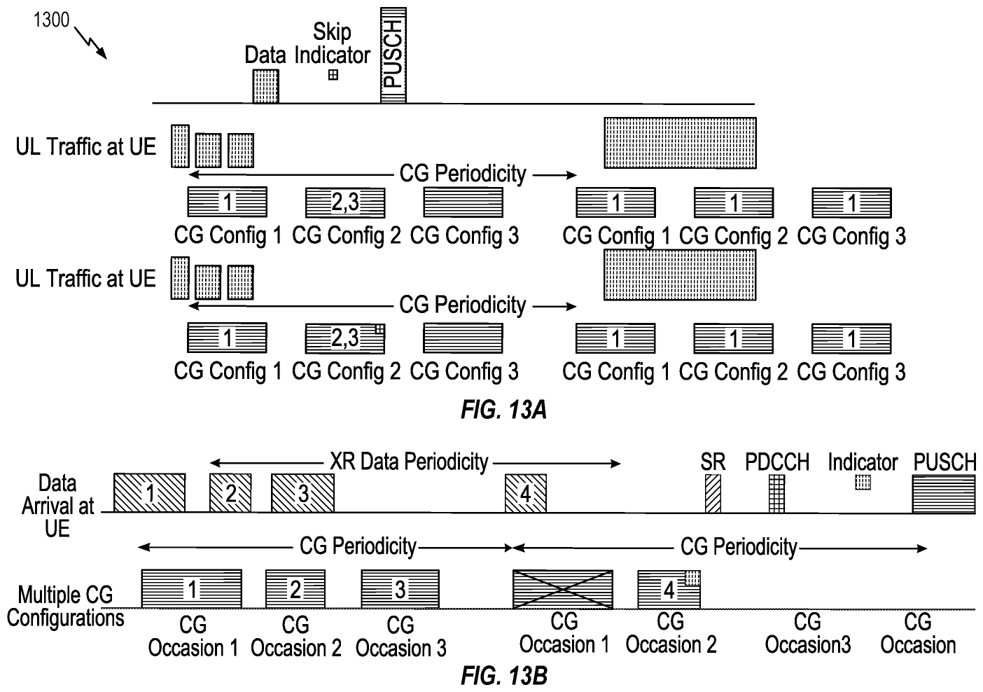

As illustrated in FIG. 13A, when one or more data bursts (i.e., bursts 1-3) arrive at a UE, the UE may transmit burst 1 in a first available CG occasion (per CG Config 1) within a data period. The UE may transmit bursts 2 and 3 in a second CG occasion (per CG Config 2) of the first data period. In a second data period, a second, larger burst may be sent in CG occasions of all 3 CG configurations. This approach may decrease latency by increasing the amount of transmission resources available to a UE during a data period, while eliminating the need for control signaling associated with dynamic signaling.

As illustrated in the timeline of in FIG. 13B, when configured with multiple CG configurations, the UE may send a skip indicator to inform a network entity that it may skip monitoring one or more CG occasions. This may help conserve resources, as one or more future CG occasions may often be empty upon transmission. As noted above, a UE may send this indicator prior to sending the skipped CG occasion, taking into account network entity processing time. In the illustrated example, the UE sends the skip indicator in the CG occasion of CG Config 2, indicating it will skip the CG occasion of CG Config 3. If a UE does not send a skip indicator, the network entity may monitor all of the configured CG occasions. In some cases, the indicator may indicate that more CG occasions than initially activated may be used within a CG configuration. This extended CG occasion indicator may be preconfigured by the network entity.

According to certain aspects, a wake up signal (WUS) may be transmitted by the UE to move a CG occasion closer to the start of a data period. The WUS may indicate, to the network, that the UE has data and the network may adjust periods accordingly. In this manner, a WUS transmission may correct latency associated with jitter. In some cases, a WUS may reduce power consumption compared to dynamic grant-based transmission.

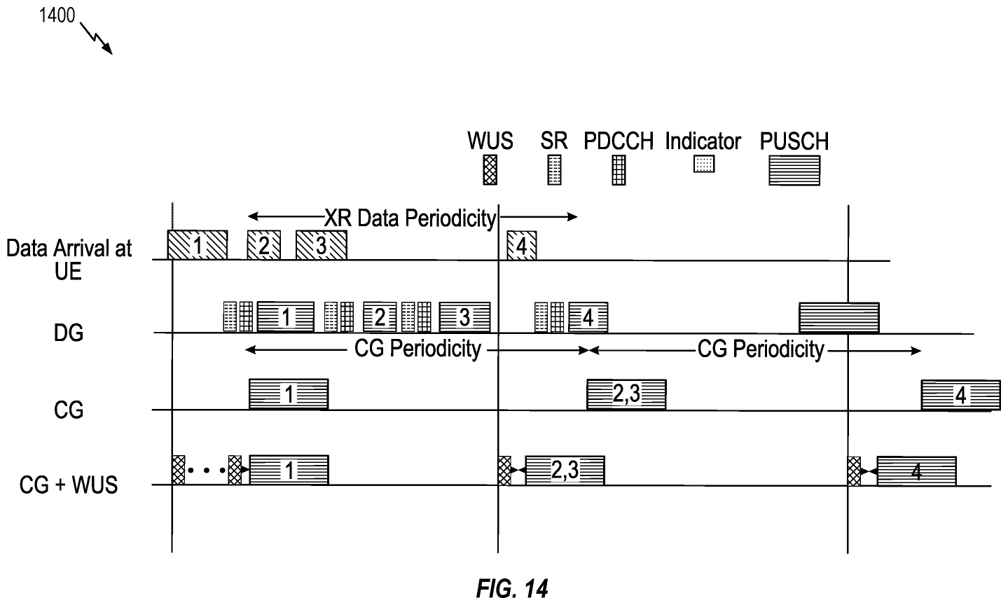

FIG. 14 illustrates a WUS-based CG configuration (in the fourth timeline). The first three timelines of FIG. 14 mirror the first three timelines of FIG. 12 and are provided for comparison. In row four of FIG. 14, the UE transmits a WUS to a network entity at the start of data period. Jitter may not be expected on the UL but in case, a WUS-based CG may be used to effectively move the CG occasions closer to data arrival in order to minimize latency. The UE may have a given window to transmit (according to) the CG and a gNB may, thus, monitor for the WUS during this window. In some cases, the WUS could be sequence based to reduce power consumption. In some cases, parameter changes for future CG occasions may be piggybacked on a WUS. A UE may transmit a WUS using sequence-based signaling (e.g., demodulation reference signaling (DMRS)), PDCCH (e.g., DCI), UCI, or PUSCH (e.g., medium access control (MAC) control element (CE)).

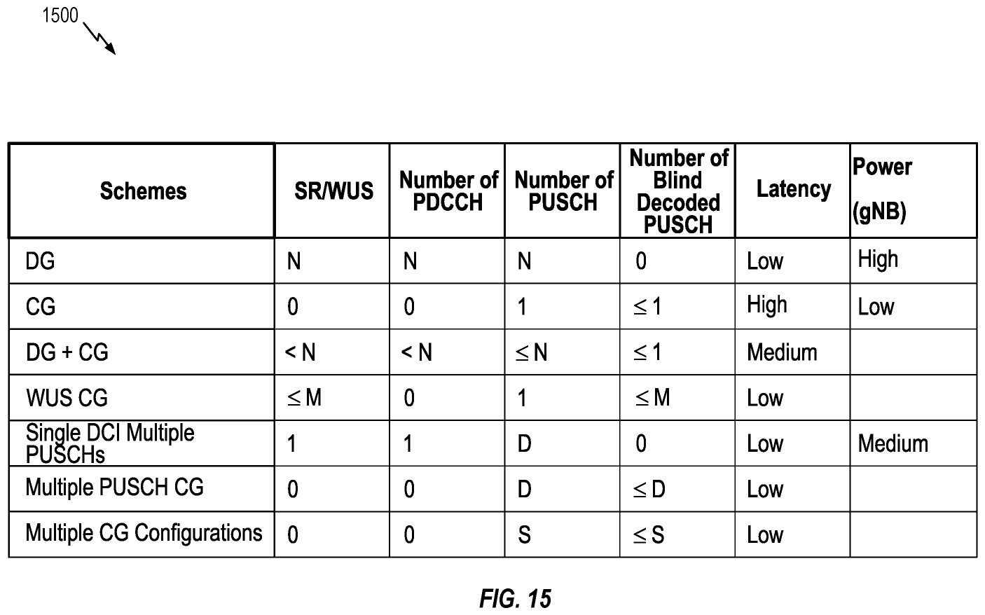

FIG. 15 is a table that summarizes various parameters associated with various scheduling schemes, including the enhanced scheduling schemes proposed herein. The first column indicates the scheduling scheme, the second column indicates the maximum number or SR/WUS signals, and the third column indicates the maximum number of PDCCHs, while the fourth column indicates the maximum number of PUSCHs. The fifth column indicates the maximum number of blind PUSCH decodes (performed at the network entity), the sixth column indicates the latency for the scheduling scheme, while the seventh column indicates the power consumption for each scheduling scheme. In the table “M” defines a maximum number of WUS in a network entity monitoring window for each configuration. “N” defines a number of packets that may be transmitted per data period. “D” defines a number of PUSCHs that may be implemented in a multiple PUSCH configuration. “S” defines a number of configured CG configurations. Relationships between M, N, D, and S may be dependent on traffic type and UE capability.

As described by FIG. 15, enhanced UL resource scheduling techniques implemented according to aspects of the present disclosure reduce latency and decrease power consumption for UL burst traffic. In particular, the table shows how the number of SRs and PDCCH transmissions are reduced (or eliminated) using the enhanced techniques proposed herein with a corresponding reduction in latency, albeit at a cost in terms of a number of blind decodes at the network entity (in some cases).

### Example Operations of a User Equipment

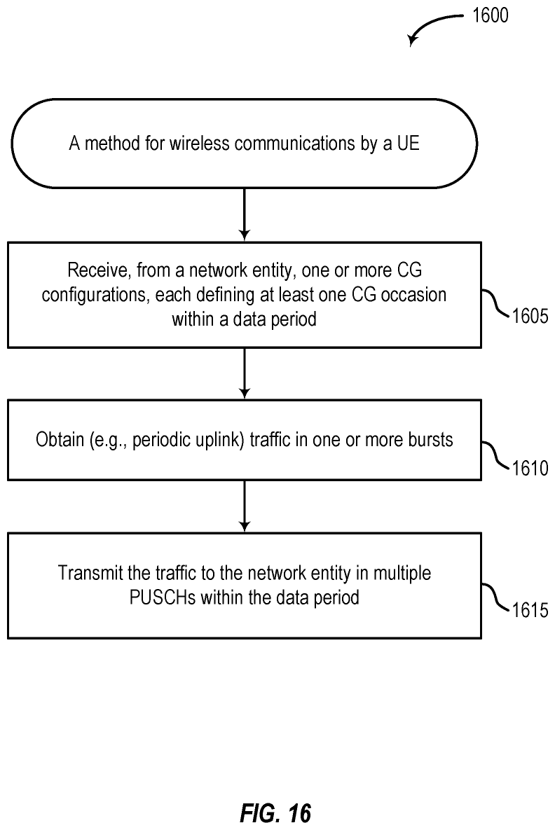

FIG. 16 shows a method 1600 for wireless communications by a UE, such as UE 104 of FIGS. 1 and 3.

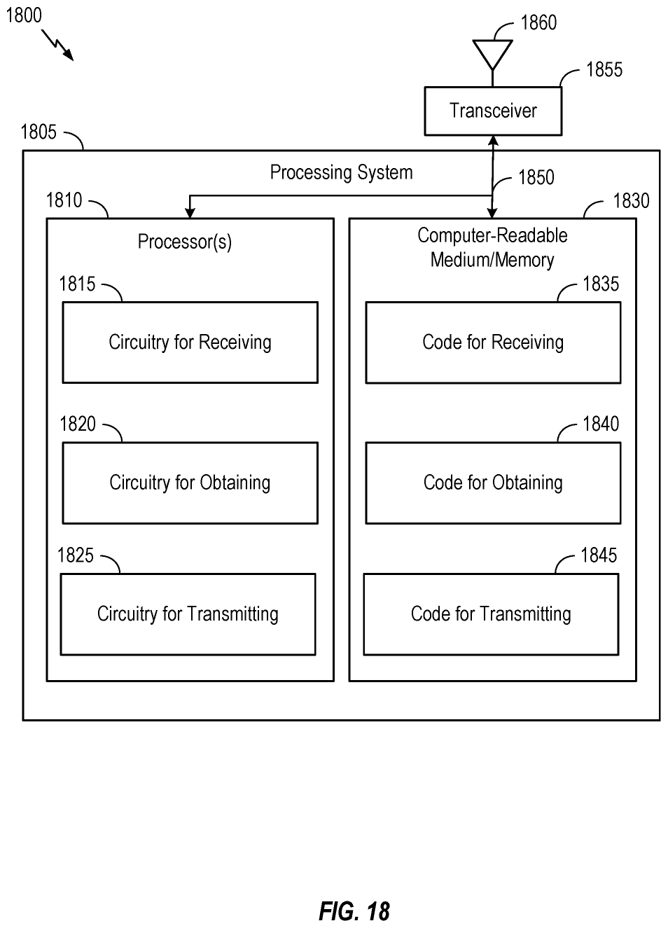

Method 1600 begins at step 1605 with receiving, from a network entity, one or more CG configurations, each defining at least one CG occasion within a data period. In some cases, the operations of this step refer to, or may be performed by, circuitry for receiving and/or code for receiving as described with reference to FIG. 18.

Method 1600 then proceeds to step 1610 with obtaining (e.g., periodic uplink) traffic in one or more bursts. In some cases, the operations of this step refer to, or may be performed by, circuitry for obtaining and/or code for obtaining as described with reference to FIG. 18.

Method 1600 then proceeds to step 1615 with transmitting the traffic to the network entity in multiple PUSCHs within the data period. In some cases, the operations of this step refer to, or may be performed by, circuitry for transmitting and/or code for transmitting as described with reference to FIG. 18.

In some aspects, the one or more CG configurations indicate a maximum number of PUSCHs for each CG occasion.

In some aspects, the one or more CG configurations also indicate CG parameters for each of the PUSCHs.

In some aspects, at least some of the transmission parameters vary: across PUSCHs within a CG occasion; or across different CG occasions within a data period.

In some aspects, the method 1600 further includes transmitting an indication that the UE does not intend to use all of the maximum number of PUSCHs within a CG occasion. In some cases, the operations of this step refer to, or may be performed by, circuitry for transmitting and/or code for transmitting as described with reference to FIG. 18.

In some aspects, the method 1600 further includes transmitting an indication at least one of: a change to one or more CG parameters for one or more subsequent PUSCHs; or a request to change to one or more CG parameters for one or more subsequent PUSCHs. In some cases, the operations of this step refer to, or may be performed by, circuitry for transmitting and/or code for transmitting as described with reference to FIG. 18.

In some aspects, the request is for a change to one or more CG parameters for one or more subsequent PUSCHs in the same CG occasion, a subsequent CG occasion, or a group of subsequent CG occasions.

In some aspects, the change or request to change is indicated via at least one of sequenced-based signaling, UCI or MAC-CE.

In some aspects, the method 1600 further includes transmitting an indication that the UE intends to use more than the maximum number of PUSCHs within a CG occasion. In some cases, the operations of this step refer to, or may be performed by, circuitry for transmitting and/or code for transmitting as described with reference to FIG. 18.

In some aspects, transmitting the traffic to the network entity in multiple PUSCHs within the data period comprises: transmitting one or more PUSCHs within the at least one CG occasion; and transmitting one or more PUSCHs scheduled via one or more dynamic grants.

In some aspects, the method 1600 further includes transmitting at least one SR, wherein at least one of the dynamic grants is sent in response to the SR. In some cases, the operations of this step refer to, or may be performed by, circuitry for transmitting and/or code for transmitting as described with reference to FIG. 18.

In some aspects, the method 1600 further includes transmitting a more data indication that triggers pre-configured PUSCH resources. In some cases, the operations of this step refer to, or may be performed by, circuitry for transmitting and/or code for transmitting as described with reference to FIG. 18.

In some aspects, the method 1600 further includes transmitting PUSCH on at least some of the pre-configured PUSCH resources. In some cases, the operations of this step refer to, or may be performed by, circuitry for transmitting and/or code for transmitting as described with reference to FIG. 18.

In some aspects, the method 1600 further includes transmitting an indication in one of the PUSCHs that indicates an end of one of the data bursts. In some cases, the operations of this step refer to, or may be performed by, circuitry for transmitting and/or code for transmitting as described with reference to FIG. 18.

In some aspects, the method 1600 further includes transmitting a more data indication in one of the PUSCHs, wherein at least one of the dynamic grants is sent in response to the more data indication. In some cases, the operations of this step refer to, or may be performed by, circuitry for transmitting and/or code for transmitting as described with reference to FIG. 18.

In some aspects, the more data indicator is transmitted via at least one of DMRS, a MAC-CE, or UCI.

In some aspects, the one or more CG configurations comprise multiple CG configurations, each having at least one associated CG occasion within the data period.

In some aspects, transmitting the traffic to the network entity in multiple PUSCHs within the data period comprises transmitting the traffic within multiple CG occasions, each associated with one of the multiple CG configurations.

In some aspects, the method 1600 further includes transmitting a more data indication that indicates the UE intends to use at least one CG occasion or CG configuration within the data period. In some cases, the operations of this step refer to, or may be performed by, circuitry for transmitting and/or code for transmitting as described with reference to FIG. 18.

In some aspects, the more data indicator also indicates a modification to one or more CG parameters.

In some aspects, the method 1600 further includes transmitting an indication that the UE does not intend to use at least one CG occasion or CG configuration within the data period. In some cases, the operations of this step refer to, or may be performed by, circuitry for transmitting and/or code for transmitting as described with reference to FIG. 18.

In some aspects, the indication is transmitted via at least one of sequence-based signaling, UCI, PUSCH, or a MAC-CE.

In some aspects, the method 1600 further includes transmitting a WUS to the network entity at the start of the data period to indicate that the UE does intend to use at least one CG occasion within the data period. In some cases, the operations of this step refer to, or may be performed by, circuitry for transmitting and/or code for transmitting as described with reference to FIG. 18.

In some aspects, the WUS is transmitted at a fixed offset from a first PUSCH transmitted by the UE.

In some aspects, the WUS also indicates a modification to one or more CG parameters.

In some aspects, the WUS is transmitted via at least one of sequenced-based signaling, UCI, or a MAC-CE.

In one aspect, method 1600, or any aspect related to it, may be performed by an apparatus, such as communications device 1800 of FIG. 18, which includes various components operable, configured, or adapted to perform the method 1600. Communications device 1800 is described below in further detail.

Note that FIG. 16 is just one example of a method, and other methods including fewer, additional, or alternative steps are possible consistent with this disclosure.

### Example Operations of a Network Entity

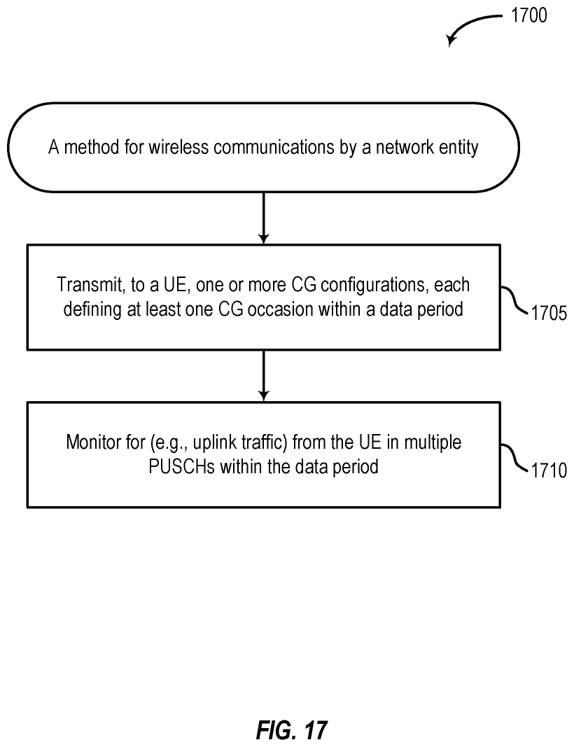

FIG. 17 shows a method 1700 for wireless communications by a network entity, such as BS 102 of FIGS. 1 and 3, or a disaggregated base station as discussed with respect to FIG. 2.

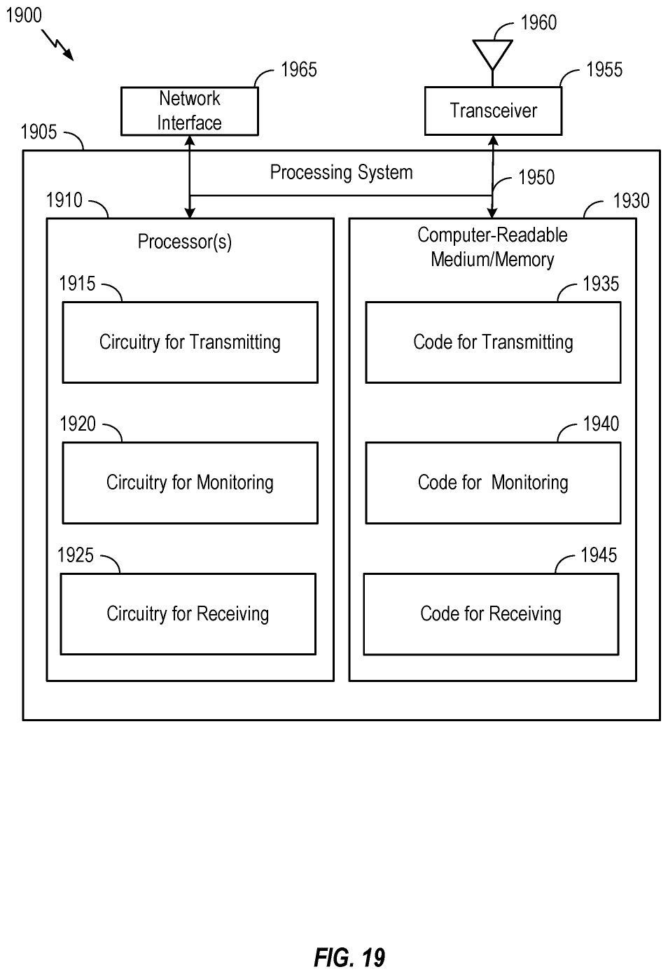

Method 1700 begins at step 1705 with transmitting, to a UE, one or more CG configurations, each defining at least one CG occasion within a data period. In some cases, the operations of this step refer to, or may be performed by, circuitry for transmitting and/or code for transmitting as described with reference to FIG. 19.

Method 1700 then proceeds to step 1710 with monitoring for uplink traffic from the UE in multiple PUSCHs within the data period. In some cases, the operations of this step refer to, or may be performed by, circuitry for monitoring and/or code for monitoring as described with reference to FIG. 19.

In some aspects, the one or more CG configurations indicate a maximum number of PUSCHs for each CG occasion.

In some aspects, the one or more CG configurations also indicate CG parameters for each of the PUSCHs.

In some aspects, at least some of the CG parameters vary: across PUSCHs within a CG occasion; or across different CG occasions within a data period.

In some aspects, the method 1700 further includes receiving an indication that the UE does not intend to use all of the maximum number of PUSCHs within a CG occasion. In some cases, the operations of this step refer to, or may be performed by, circuitry for receiving and/or code for receiving as described with reference to FIG. 19.

In some aspects, the method 1700 further includes monitoring for an indication at least one of: a change to one or more CG parameters for one or more subsequent PUSCHs; or a request to change to one or more CG parameters for one or more subsequent PUSCHs. In some cases, the operations of this step refer to, or may be performed by, circuitry for monitoring and/or code for monitoring as described with reference to FIG. 19

In some aspects, the request is for a change to one or more CG parameters for one or more subsequent PUSCHs in the same CG occasion, a subsequent CG occasion, or a group of subsequent CG occasions.

In some aspects, the change or request to change is indicated via at least one of sequenced-based signaling, UCI or MAC-CE.

In some aspects, the method 1700 further includes monitoring for an indication that the UE intends to use more than the maximum number of PUSCHs within a CG occasion. In some cases, the operations of this step refer to, or may be performed by, circuitry for monitoring and/or code for monitoring as described with reference to FIG. 19

In some aspects, monitoring the uplink traffic from the UE in multiple PUSCHs within the data period comprises: monitoring for one or more PUSCHs within the at least one CG occasion; and monitoring for one or more PUSCHs scheduled via one or more dynamic grants.

In some aspects, the method 1700 further includes monitoring for at least one SR. In some cases, the operations of this step refer to, or may be performed by, circuitry for monitoring and/or code for monitoring as described with reference to FIG. 19

In some aspects, the method 1700 further includes transmitting at least one of the dynamic grants in response to the at least one SR. In some cases, the operations of this step refer to, or may be performed by, circuitry for transmitting and/or code for transmitting as described with reference to FIG. 19.

In some aspects, the method 1700 further includes monitoring for a more data indication that triggers pre-configured PUSCH resources. In some cases, the operations of this step refer to, or may be performed by, circuitry for monitoring and/or code for monitoring as described with reference to FIG. 19

In some aspects, the method 1700 further includes monitoring for PUSCH on at least some of the pre-configured PUSCH resources. In some cases, the operations of this step refer to, or may be performed by, circuitry for monitoring and/or code for monitoring as described with reference to FIG. 19

In some aspects, the method 1700 further includes monitoring for an indication in one of the PUSCHs that indicates an end of one of the data bursts. In some cases, the operations of this step refer to, or may be performed by, circuitry for monitoring and/or code for monitoring as described with reference to FIG. 19

In some aspects, the method 1700 further includes monitoring for a more data indication in one of the PUSCHs, wherein at least one of the dynamic grants is sent in response to the more data indication. In some cases, the operations of this step refer to, or may be performed by, circuitry for monitoring and/or code for monitoring as described with reference to FIG. 19

In some aspects, the more data indicator is transmitted via at least one of DMRS, a MAC-CE, or UCI.

In some aspects, the one or more CG configurations comprise multiple CG configurations, each having at least one associated CG occasion within the data period.

In some aspects, the monitoring for uplink traffic from the UE in multiple PUSCHs within the data period comprises monitoring for the traffic within multiple CG occasions, each associated with one of the multiple CG configurations.

In some aspects, the method 1700 further includes monitoring for a more data indication that indicates the UE intends to use at least one CG occasion or CG configuration within the data period. In some cases, the operations of this step refer to, or may be performed by, circuitry for monitoring and/or code for monitoring as described with reference to FIG. 19

In some aspects, the more data indicator also indicates a modification to one or more CG parameters.

In some aspects, the method 1700 further includes monitoring for an indication that the UE does not intend to use at least one CG occasion or CG configuration within the data period. In some cases, the operations of this step refer to, or may be performed by, circuitry for monitoring and/or code for monitoring as described with reference to FIG. 19

In some aspects, the indication is transmitted via at least one of sequence-based signaling, UCI, PUSCH, or a MAC-CE.

In some aspects, the method 1700 further includes monitoring for a WUS from the UE at the start of the data period to indicate that the UE does intend to use at least one CG occasion within the data period. In some cases, the operations of this step refer to, or may be performed by, circuitry for monitoring and/or code for monitoring as described with reference to FIG. 19

In some aspects, the WUS also indicates a modification to one or more CG parameters.

In some aspects, the WUS is transmitted at a fixed offset from a first PUSCH transmitted by the UE.

In some aspects, the WUS is transmitted via at least one of sequenced-based signaling, UCI, or a MAC-CE.

In one aspect, method 1700, or any aspect related to it, may be performed by an apparatus, such as communications device 1900 of FIG. 19, which includes various components operable, configured, or adapted to perform the method 1700. Communications device 1900 is described below in further detail.

Note that FIG. 17 is just one example of a method, and other methods including fewer, additional, or alternative steps are possible consistent with this disclosure.

### Example Communications Devices

FIG. 18 depicts aspects of an example communications device 1800. In some aspects, communications device 1800 is a user equipment, such as UE 104 described above with respect to FIGS. 1 and 3.

The communications device 1800 includes a processing system 1805 coupled to the transceiver 1855 (e.g., a transmitter and/or a receiver). The transceiver 1855 is configured to transmit and receive signals for the communications device 1800 via the antenna 1860, such as the various signals as described herein. The processing system 1805 may be configured to perform processing functions for the communications device 1800, including processing signals received and/or to be transmitted by the communications device 1800.

The processing system 1805 includes one or more processors 1810. In various aspects, the one or more processors 1810 may be representative of one or more of receive processor 358, transmit processor 364, TX MIMO processor 366, and/or controller/processor 380, as described with respect to FIG. 3. The one or more processors 1810 are coupled to a computer-readable medium/memory 1830 via a bus 1850. In certain aspects, the computer-readable medium/memory 1830 is configured to store instructions (e.g., computer-executable code) that when executed by the one or more processors 1810, cause the one or more processors 1810 to perform the method 1600 described with respect to FIG. 16, or any aspect related to it. Note that reference to a processor performing a function of communications device 1800 may include one or more processors 1810 performing that function of communications device 1800.

In the depicted example, computer-readable medium/memory 1830 stores code (e.g., executable instructions), such as code for receiving 1835, code for obtaining 1840, and code for transmitting 1845. Processing of the code for receiving 1835, code for obtaining 1840, and code for transmitting 1845 may cause the communications device 1800 to perform the method 1600 described with respect to FIG. 16, or any aspect related to it.

The one or more processors 1810 include circuitry configured to implement (e.g., execute) the code stored in the computer-readable medium/memory 1830, including circuitry such as circuitry for receiving 1815, circuitry for obtaining 1820, and circuitry for transmitting 1825. Processing with circuitry for receiving 1815, circuitry for obtaining 1820, and circuitry for transmitting 1825 may cause the communications device 1800 to perform the method 1600 described with respect to FIG. 16, or any aspect related to it.

Various components of the communications device 1800 may provide means for performing the method 1600 described with respect to FIG. 16, or any aspect related to it. For example, means for transmitting, sending or outputting for transmission may include transceivers 354 and/or antenna(s) 352 of the UE 104 illustrated in FIG. 3 and/or the transceiver 1855 and the antenna 1860 of the communications device 1800 in FIG. 18. Means for receiving or obtaining may include transceivers 354 and/or antenna(s) 352 of the UE 104 illustrated in FIG. 3 and/or the transceiver 1855 and the antenna 1860 of the communications device 1800 in FIG. 18.

FIG. 19 depicts aspects of an example communications device 1900. In some aspects, communications device 1900 is a network entity, such as BS 102 of FIGS. 1 and 3, or a disaggregated base station as discussed with respect to FIG. 2.

The communications device 1900 includes a processing system 1905 coupled to the transceiver 1955 (e.g., a transmitter and/or a receiver) and/or a network interface 1965. The transceiver 1955 is configured to transmit and receive signals for the communications device 1900 via the antenna 1960, such as the various signals as described herein. The network interface 1965 is configured to obtain and send signals for the communications device 1900 via communication link(s), such as a backhaul link, midhaul link, and/or fronthaul link as described herein, such as with respect to FIG. 2. The processing system 1905 may be configured to perform processing functions for the communications device 1900, including processing signals received and/or to be transmitted by the communications device 1900.

The processing system 1905 includes one or more processors 1910. In various aspects, one or more processors 1910 may be representative of one or more of receive processor 338, transmit processor 320, TX MIMO processor 330, and/or controller/processor 340, as described with respect to FIG. 3. The one or more processors 1910 are coupled to a computer-readable medium/memory 1930 via a bus 1950. In certain aspects, the computer-readable medium/memory 1930 is configured to store instructions (e.g., computer-executable code) that when executed by the one or more processors 1910, cause the one or more processors 1910 to perform the method 1700 described with respect to FIG. 17, or any aspect related to it. Note that reference to a processor of communications device 1900 performing a function may include one or more processors 1910 of communications device 1900 performing that function.

In the depicted example, the computer-readable medium/memory 1930 stores code (e.g., executable instructions), such as code for transmitting 1935, code for monitoring 1940, and code for receiving 1945. Processing of the code for transmitting 1935, code for monitoring 1940, and code for receiving 1945 may cause the communications device 1900 to perform the method 1700 described with respect to FIG. 17, or any aspect related to it.

The one or more processors 1910 include circuitry configured to implement (e.g., execute) the code stored in the computer-readable medium/memory 1930, including circuitry such as circuitry for transmitting 1915, circuitry for monitoring 1920, and circuitry for receiving 1925. Processing with circuitry for transmitting 1915, circuitry for monitoring 1920, and circuitry for receiving 1925 may cause the communications device 1900 to perform the method 1700 as described with respect to FIG. 17, or any aspect related to it.

Various components of the communications device 1900 may provide means for performing the method 1700 as described with respect to FIG. 17, or any aspect related to it. Means for transmitting, sending or outputting for transmission may include transceivers 332 and/or antenna(s) 334 of the BS 102 illustrated in FIG. 3 and/or the transceiver 1955 and the antenna 1960 of the communications device 1900 in FIG. 19. Means for receiving or obtaining may include transceivers 332 and/or antenna(s) 334 of the BS 102 illustrated in FIG. 3 and/or the transceiver 1955 and the antenna 1960 of the communications device 1900 in FIG. 19.

### Example Clauses

Implementation examples are described in the following numbered clauses:

Clause 1: A method for wireless communications by a UE, comprising: receiving, from a network entity, one or more CG configurations, each defining at least one CG occasion within a data period; obtaining traffic in one or more bursts; and transmitting the traffic to the network entity in multiple PUSCHs within the data period.

Clause 2: The method of clause 1, wherein the one or more CG configurations indicate a maximum number of PUSCHs for each CG occasion.

Clause 3: The method of clause 2, wherein the one or more CG configurations also indicate CG parameters for each of the PUSCHs.

Clause 4: The method of clause 3, wherein at least some of the transmission parameters vary: across PUSCHs within a CG occasion; or across different CG occasions within a data period.

Clause 5: The method of clause 2, further comprising: transmitting an indication that the UE does not intend to use all of the maximum number of PUSCHs within a CG occasion.

Clause 6: The method of clause 5, further comprising transmitting an indication at least one of: a change to one or more CG parameters for one or more subsequent PUSCHs; or a request to change to one or more CG parameters for one or more subsequent PUSCHs.

Clause 7: The method of clause 6, wherein the request is for a change to one or more CG parameters for one or more subsequent PUSCHs in the same CG occasion, a subsequent CG occasion, or a group of subsequent CG occasions.

Clause 8: The method of clause 6, wherein the change or request to change is indicated via at least one of sequenced-based signaling, UCI or MAC-CE.

Clause 9: The method of clause 2, further comprising: transmitting an indication that the UE intends to use more than the maximum number of PUSCHs within a CG occasion.

Clause 10: The method of clause 2, wherein transmitting the traffic to the network entity in multiple PUSCHs within the data period comprises: transmitting one or more PUSCHs within the at least one CG occasion; and transmitting one or more PUSCHs scheduled via one or more dynamic grants.

Clause 11: The method of clause 10, the method further comprising: transmitting at least one SR, wherein at least one of the dynamic grants is sent in response to the SR.

Clause 12: The method of clause 10, further comprising: transmitting a more data indication that triggers pre-configured PUSCH resources; and transmitting PUSCH on at least some of the pre-configured PUSCH resources.

Clause 13: The method of clause 10, further comprising: transmitting an indication in one of the PUSCHs that indicates an end of one of the data bursts.

Clause 14: The method of clause 10, further comprising: transmitting a more data indication in one of the PUSCHs, wherein at least one of the dynamic grants is sent in response to the more data indication.

Clause 15: The method of clause 14, wherein the more data indicator is transmitted via at least one of DMRS, a MAC-CE, or UCI.

Clause 16: The method of any one of clauses 1-15, wherein the one or more CG configurations comprise multiple CG configurations, each having at least one associated CG occasion within the data period.

Clause 17: The method of clause 16, wherein transmitting the traffic to the network entity in multiple PUSCHs within the data period comprises transmitting the traffic within multiple CG occasions, each associated with one of the multiple CG configurations.

Clause 18: The method of clause 16, further comprising: transmitting a more data indication that indicates the UE intends to use at least one CG occasion or CG configuration within the data period.

Clause 19: The method of clause 16, wherein the more data indicator also indicates a modification to one or more CG parameters.

Clause 20: The method of clause 16, further comprising: transmitting an indication that the UE does not intend to use at least one CG occasion or CG configuration within the data period.

Clause 21: The method of clause 20, wherein the indication is transmitted via at least one of sequence-based signaling, UCI, PUSCH, or a MAC-CE.

Clause 22: The method of any one of clauses 1-21, further comprising: transmitting a WUS to the network entity at the start of the data period to indicate that the UE does intend to use at least one CG occasion within the data period.

Clause 23: The method of clause 22, wherein the WUS is transmitted at a fixed offset from a first PUSCH transmitted by the UE.

Clause 24: The method of clause 22, wherein the WUS also indicates a modification to one or more CG parameters.

Clause 25: The method of clause 22, wherein the WUS is transmitted via at least one of sequenced-based signaling, UCI, or a MAC-CE.

Clause 26: A method for wireless communications by a network entity, comprising: transmitting, to a UE, one or more CG configurations, each defining at least one CG occasion within a data period; and monitoring for uplink traffic from the UE in multiple PUSCHs within the data period.

Clause 27: The method of clause 26, wherein the one or more CG configurations indicate a maximum number of PUSCHs for each CG occasion.

Clause 28: The method of clause 27, wherein the one or more CG configurations also indicate CG parameters for each of the PUSCHs.

Clause 29: The method of clause 28, wherein at least some of the CG parameters vary: across PUSCHs within a CG occasion; or across different CG occasions within a data period.

Clause 30: The method of clause 27, further comprising receiving an indication that the UE does not intend to use all of the maximum number of PUSCHs within a CG occasion.

Clause 31: The method of clause 30, further comprising monitoring for an indication at least one of: a change to one or more CG parameters for one or more subsequent PUSCHs; or a request to change to one or more CG parameters for one or more subsequent PUSCHs.

Clause 32: The method of clause 31, wherein the request is for a change to one or more CG parameters for one or more subsequent PUSCHs in the same CG occasion, a subsequent CG occasion, or a group of subsequent CG occasions.

Clause 33: The method of clause 31, wherein the change or request to change is indicated via at least one of sequenced-based signaling, UCI or MAC-CE.

Clause 34: The method of clause 27, further comprising: monitoring for an indication that the UE intends to use more than the maximum number of PUSCHs within a CG occasion.

Clause 35: The method of clause 27, wherein monitoring the uplink traffic from the UE in multiple PUSCHs within the data period comprises: monitoring for one or more PUSCHs within the at least one CG occasion; and monitoring for one or more PUSCHs scheduled via one or more dynamic grants.

Clause 36: The method of clause 35, the method further comprising: monitoring for at least one SR; and transmitting at least one of the dynamic grants in response to the at least one SR.

Clause 37: The method of clause 35, further comprising: monitoring for a more data indication that triggers pre-configured PUSCH resources; and monitoring for PUSCH on at least some of the pre-configured PUSCH resources.

Clause 38: The method of clause 35, further comprising: monitoring for an indication in one of the PUSCHs that indicates an end of one of the data bursts.

Clause 39: The method of clause 35, further comprising: monitoring for a more data indication in one of the PUSCHs, wherein at least one of the dynamic grants is sent in response to the more data indication.

Clause 40: The method of clause 39, wherein the more data indicator is transmitted via at least one of DMRS, a MAC-CE, or UCI.

Clause 41: The method of any one of clauses 26-40, wherein the one or more CG configurations comprise multiple CG configurations, each having at least one associated CG occasion within the data period.

Clause 42: The method of clause 41, wherein the monitoring for uplink traffic from the UE in multiple PUSCHs within the data period comprises monitoring for the traffic within multiple CG occasions, each associated with one of the multiple CG configurations.

Clause 43: The method of clause 41, further comprising: monitoring for a more data indication that indicates the UE intends to use at least one CG occasion or CG configuration within the data period.

Clause 44: The method of clause 41, wherein the more data indicator also indicates a modification to one or more CG parameters.

Clause 45: The method of clause 41, further comprising: monitoring for an indication that the UE does not intend to use at least one CG occasion or CG configuration within the data period.

Clause 46: The method of clause 45, wherein the indication is transmitted via at least one of sequence-based signaling, UCI, PUSCH, or a MAC-CE.

Clause 47: The method of any one of clauses 26-46, further comprising: monitoring for a WUS from the UE at the start of the data period to indicate that the UE does intend to use at least one CG occasion within the data period.

Clause 48: The method of clause 47, wherein the WUS also indicates a modification to one or more CG parameters.

Clause 49: The method of clause 47, wherein the WUS is transmitted at a fixed offset from a first PUSCH transmitted by the UE.

Clause 50: The method of clause 49, wherein the WUS is transmitted via at least one of sequenced-based signaling, UCI, or a MAC-CE.

Clause 51: An apparatus, comprising: a memory comprising executable instructions; and a processor configured to execute the executable instructions and cause the apparatus to perform a method in accordance with any one of Clauses 1-50.

Clause 52: An apparatus, comprising means for performing a method in accordance with any one of Clauses 1-50.

Clause 53: A non-transitory computer-readable medium comprising executable instructions that, when executed by a processor of an apparatus, cause the apparatus to perform a method in accordance with any one of Clauses 1-50.

Clause 54: A computer program product embodied on a computer-readable storage medium comprising code for performing a method in accordance with any one of Clauses 1-50.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communications by a user equipment (UE), comprising:
receiving, from a network entity, one or more configured grant (CG) configurations, each defining at least one CG occasion within a data period; and
obtaining traffic in one or more bursts; and
transmitting the traffic to the network entity in multiple physical uplink shared channel (PUSCHs) within the data period.

2. The method of claim 1, wherein:
the one or more CG configurations indicate a maximum number of PUSCHs for each CG occasion.

3. The method of claim 2, wherein the one or more CG configurations also indicate CG parameters for each of the PUSCHs.

4. The method of claim 3, wherein at least some of the CG parameters vary:
across PUSCHs within a CG occasion; or
across different CG occasions within a data period.

5. The method of claim 2, further comprising transmitting an indication that the UE does not intend to use all of the maximum number of PUSCHs within a CG occasion.

6. The method of claim 5, further comprising transmitting an indication at least one of:
a change to one or more CG parameters for one or more subsequent PUSCHs; or
a request to change to one or more CG parameters for one or more subsequent PUSCHs.

7. The method of claim 6, wherein the request is for a change to one or more CG parameters for one or more subsequent PUSCHs in the same CG occasion, a subsequent CG occasion, or a group of subsequent CG occasions.

8. The method of claim 6, wherein the change or request to change is indicated via at least one of sequenced-based signaling, uplink control information (UCI) or medium access control (MAC) control element (CE).

9. The method of claim 2, further comprising transmitting an indication that the UE intends to use more than the maximum number of PUSCHs within a CG occasion.

10. The method of claim 2, wherein transmitting the traffic to the network entity in multiple PUSCHs within the data period comprises:
transmitting one or more PUSCHs within the at least one CG occasion; and
transmitting one or more PUSCHs scheduled via one or more dynamic grants.

11. The method of claim 10, further comprising:
transmitting at least one scheduling request (SR), wherein at least one of the dynamic grants is sent in response to the SR.

12. The method of claim 10, further comprising:
transmitting a more data indication that triggers pre-configured PUSCH resources; and
transmitting PUSCH on at least some of the pre-configured PUSCH resources.

13. The method of claim 10, further comprising transmitting an indication in one of the PUSCHs that indicates an end of one of the bursts.

14. The method of claim 10, further comprising:
transmitting a more data indication in one of the PUSCHs, wherein at least one of the dynamic grants is sent in response to the more data indication.

15. The method of claim 14, wherein the more data indicator is transmitted via at least one of demodulation reference signal (DMRS), a medium access control (MAC) control element (CE), or uplink control information (UCI).

16. The method of claim 1, wherein the one or more CG configurations comprise multiple CG configurations, each having at least one associated CG occasion within the data period.

17. The method of claim 16, wherein transmitting the traffic to the network entity in multiple PUSCHs within the data period comprises transmitting the traffic within multiple CG occasions, each associated with one of the multiple CG configurations.

18. The method of 16, further comprising transmitting a more data indication that indicates the UE intends to use at least one CG occasion or CG configuration within the data period.

19. The method of 16, wherein the more data indicator also indicates a modification to one or more CG parameters.

20. The method of claim 16, further comprising transmitting an indication that the UE does not intend to use at least one CG occasion or CG configuration within the data period.

21. The method of claim 20, wherein the indication is transmitted via at least one of sequence-based signaling, uplink control information (UCI), PUSCH, or a medium access control (MAC) control element (CE).

22. The method of claim 1, further comprising:
transmitting a wake-up signal (WUS) to the network entity at a start of the data period to indicate that the UE does intend to use at least one CG occasion within the data period.

23. The method of claim 22, wherein the WUS is transmitted at a fixed offset from a first PUSCH transmitted by the UE.

24. The method of 22, wherein the WUS also indicates a modification to one or more CG parameters.

25. The method of claim 22, wherein the WUS is transmitted via at least one of sequenced-based signaling, uplink control information (UCI), or a medium access control (MAC) control element (CE).

26. A method for wireless communications by a network entity, comprising:
transmitting, to a user equipment (UE), one or more configured grant (CG) configurations, each defining at least one CG occasion within a data period; and
monitoring for uplink traffic from the UE in multiple physical uplink shared channel (PUSCHs) within the data period.

27. The method of claim 26, wherein:
the one or more CG configurations indicate a maximum number of PUSCHs for each CG occasion.

28. The method of claim 26, wherein the one or more CG configurations comprise multiple CG configurations, each having at least one associated CG occasion within the data period.

29. A user equipment (UE) configured for wireless communication, comprising: a memory comprising computer-executable instructions; and one or more processors configured to execute the computer-executable instructions and cause the UE to:
receive, from a network entity, one or more configured grant (CG) configurations, each defining at least one CG occasion within a data period; and
obtain traffic in one or more bursts; and
transmit the traffic to the network entity in multiple physical uplink shared channel (PUSCHs) within the data period.

30. A network entity configured for wireless communication, comprising: a memory comprising computer-executable instructions; and one or more processors configured to execute the computer-executable instructions and cause the network entity to:
transmit, to a user equipment (UE), one or more configured grant (CG) configurations, each defining at least one CG occasion within a data period; and
monitor for uplink traffic from the UE in multiple physical uplink shared channel (PUSCHs) within the data period.
